(19) United States
(12) Patent Application Publication
(10) Pub. No.: US 2023/0351514 A1
(43) Pub. Date: Nov. 2, 2023

(54) APPARATUS AND METHOD FOR AUTOMATIC UNCLAIMED PROPERTY SEARCH AND PROCESSING

(71) Applicant: John Thomas Eagan, III, Crown Point, IN (US)

(72) Inventor: John Thomas Eagan, III, Crown Point, IN (US)

(21) Appl. No.: 18/139,552

(22) Filed: Apr. 26, 2023

Related U.S. Application Data
(60) Provisional application No. 63/336,286, filed on Apr. 28, 2022.

(51) Int. Cl. G06Q 40/06; G06N 5/025

(52) U.S. Cl. CPC G06Q 40/06; G06N 5/025

(57) ABSTRACT

An apparatus and methods for automatically searching for, and claiming, unclaimed property. In some example embodiments, a computing device obtains tax data from a database. The computing device applies one or more processes, such as an artificial intelligence or machine learning process, to the tax data to generate search data for an unclaimed property digital interface provided by an unclaimed property processing device. Further, the computing device transmits the property search data to the unclaimed property processing device, causing the unclaimed property processing device to perform a search of unclaimed property based on the property search data. The computing device also receives, from the unclaimed property processing device, unclaimed property data. The computing device further transmits the unclaimed property data for display.

### CROSS-REFERENCE TO RELATED APPLICATIONS

This application claims the benefit of U.S. Provisional Patent Application No. 63/336,286, filed Apr. 28, 2022, which is hereby incorporated by reference in its entirety.

### FIELD OF THE INVENTION

The disclosure relates generally to processes for searching for, and claiming, unclaimed property.

### BACKGROUND

A dormant financial asset, i.e., a financial asset that meets a criteria for dormancy, can be referred to as an “unclaimed property.” Dormancy of a financial asset occurs when there is no activity by the financial asset's owner for a period of time. Once dormancy has been established, the financial asset is considered unclaimed property. Example financial asset categories include, but are not limited to, unclaimed wages or commissions, savings and checking accounts, stock dividends, insurance proceeds, underlying shares, customer deposits or overpayments, certificates of deposit, credit balances, refunds, money orders, and safe deposit box contents, among others.

When a holder of a financial asset determines that the asset has been abandoned, the holder may (e.g., must) escheat the property to a state governmental authority, for example, the Office of the Attorney General, where the asset is held in a custodial fashion by the State as unclaimed property. Typically, the proper jurisdiction for escheatment is based on a First Priority Rule, where the asset is remitted to the jurisdiction of the owner's last known address. To the extent this information is nonexistent or unreliable, the Second Priority Rule is typically followed, where the asset is remitted to the Holder's State of Incorporation or Formation.

There are several issues with returning unclaimed property to a rightful owner. For example, rightful owners of unclaimed property may not know in which jurisdiction to search for unclaimed property, or may not even know to search for unclaimed property in a particular jurisdiction. In addition, an otherwise rightful owner may not even know that a particular asset may be claimed, or may not put forth the effort needed to locate and claim the asset. As such, there are opportunities to address these and other problems associated with locating and claiming unclaimed assets.

### SUMMARY

In some examples, a computing device includes a memory storing instructions and at least one processor communicatively coupled to the memory. The at least one processor is configured to execute the instructions to obtain tax data from a database. The at least one processor is also configured to execute the instructions to generate, based on the tax data, property search data for an unclaimed property digital interface provided by an unclaimed property processing device. Further, the at least one processor is configured to execute the instructions to transmit the property search data to the unclaimed property processing device. The at least one processor is also configured to execute the instructions to receive, from the unclaimed property processing device, unclaimed property data. The at least one processor is further configured to execute the instructions to provide the unclaimed property data for display.

In some examples, a method by at least one processor includes obtaining tax data from a database. The method also includes generating, based on the tax data, property search data for an unclaimed property digital interface provided by an unclaimed property processing device. Further, the method includes transmitting the property search data to the unclaimed property processing device. The method also includes receiving, from the unclaimed property processing device, unclaimed property data. The method further includes providing the unclaimed property data for display.

In some examples, a non-transitory computer readable medium stores instructions wherein the instructions, when executed by at least one processor, cause a device to perform operations. The operations include obtaining tax data from a database. The operations also include generating, based on the tax data, property search data for an unclaimed property digital interface provided by an unclaimed property processing device. Further, the operations include transmitting the property search data to the unclaimed property processing device. The operations also include receiving, from the unclaimed property processing device, unclaimed property data. The operations further include providing the unclaimed property data for display.

### BRIEF DESCRIPTION OF THE DRAWINGS

The features and advantages of the present disclosure will be more fully disclosed in, or rendered obvious by the following detailed description of example embodiments. The detailed description of example embodiments should be considered together with the accompanying drawings, wherein like numbers refer to like parts and further wherein:

FIG. 1 is a block diagram of a property search and claim system, in accordance with some embodiments;

FIG. 2 is a block diagram of a property search and claim computing device, in accordance with some embodiments;

FIG. 3 is a block diagram illustrating messaging between various components of a property search and claim system, in accordance with some embodiments;

FIGS. 4A and 4B illustrate exemplary portions of a property search and claim computing device, in accordance with some embodiments;

FIG. 5 illustrates an exemplary digital interface with queries, in accordance with some embodiments;

FIG. 6A illustrates an unclaimed property search digital interface, in accordance with some embodiments;

FIG. 6B illustrates a property search results digital interface, in accordance with some embodiments;

FIG. 7 is a flowchart of an example method that can be carried out by a property search and claim computing device, in accordance with some embodiments; and

FIG. 8 is a flowchart of another example method that can be carried out by a property search and claim computing device, in accordance with some embodiments.

### DETAILED DESCRIPTION

The description of example embodiments is intended to be read in connection with the accompanying drawings, which are to be considered part of the entire written description of the disclosure. While the present disclosure is susceptible to various modifications and alternative forms, specific example embodiments are shown by way of example in the drawings and will be described in detail herein. The objectives and advantages of the claimed subject matter will become more apparent from the following detailed description of these example embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these example embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

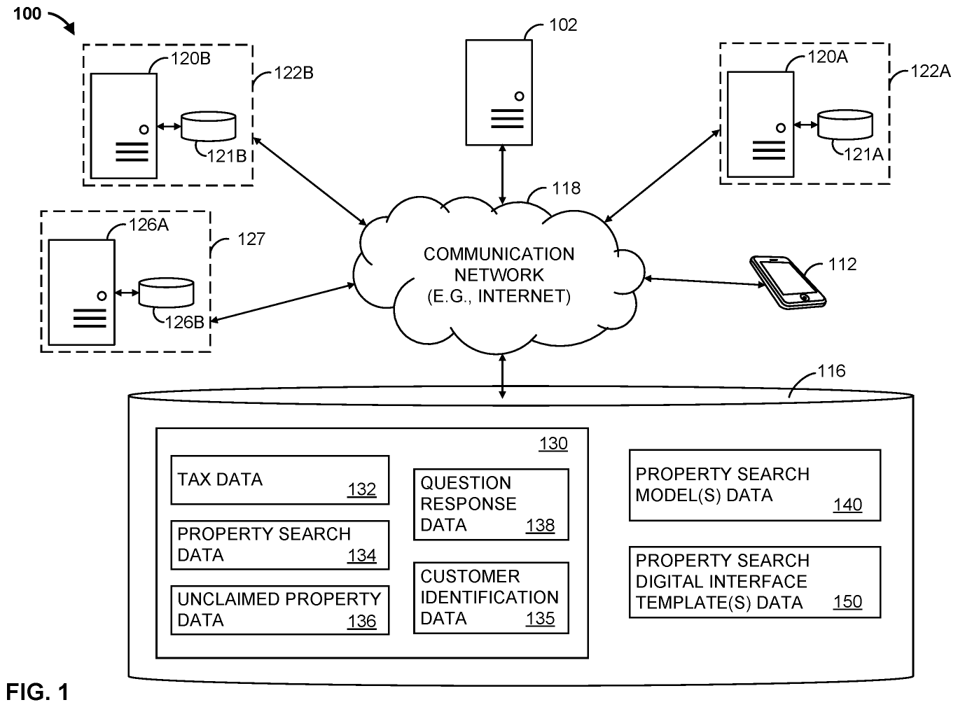

Turning to the drawings, FIG. 1 illustrates a block diagram of a property search and claim system 100 that includes a property search and claim computing device 102, one or more unclaimed property search devices 120A, 120B, one or more data retrieval devices 126A, database 116, and one or more user computing devices 112 communicatively coupled over network 118. Property search and claim computing device 102, unclaimed property search devices 120A, 120B, data retrieval device 126A, and user computing devices 112 can each be any suitable computing device that includes any hardware or hardware and software combination for processing data. For example, each of property search and claim computing device 102, unclaimed property search devices 120A, 120B, data retrieval device 126A, and user computing devices 112 can include one or more processors, one or more field-programmable gate arrays (FPGAs), one or more application-specific integrated circuits (ASICs), one or more state machines, digital circuitry, or any other suitable circuitry for processing data.

In example embodiments, each of property search and claim computing device 102, unclaimed property search devices 120A, 120B, and data retrieval device 126A can be a server such as a cloud-based server or an application server, a computer, a workstation, a laptop, or any other suitable device. Each user computing device 112 can be a computer, a workstation, a laptop, a tablet, a personal assistant device, a voice assistant device, a digital assistant device, a mobile device such as a cellular phone or smart phone, or any other suitable device. In addition, each of property search and claim computing device 102, unclaimed property search devices 120A, 120B, data retrieval device 126A, and user computing device 112 can transmit data to, and receive data from, communication network 118.

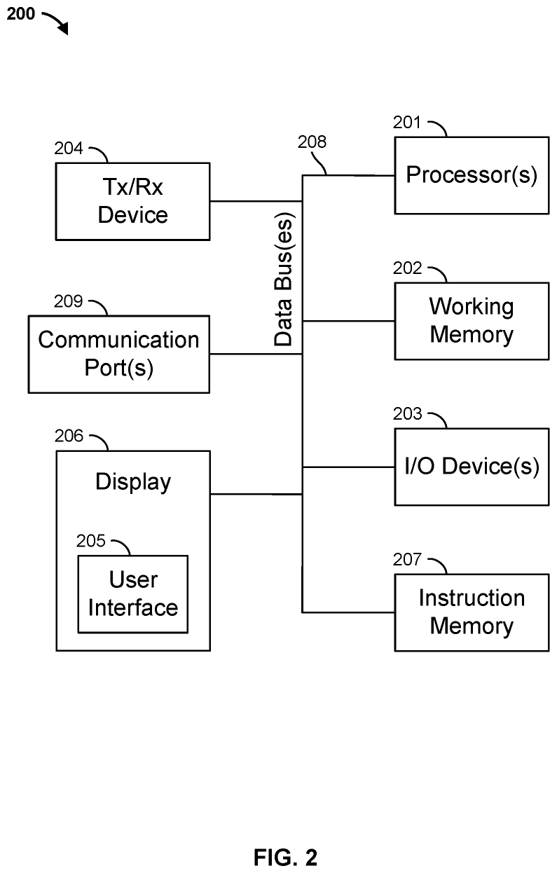

FIG. 2 illustrates an example property search and claim computing device 102. In this example, property search and claim computing device 102 includes one or more processors 201, working memory 202, one or more input/output (I/O) devices 203, instruction memory 207, a transceiver 204, one or more communication ports 209, and a display 206 including a user interface 205, all operatively coupled to one or more data buses 208. Data buses 208 allow for communication among the various devices. Data buses 208 can include wired and/or wireless communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory, an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of property search and claim computing device 102. Working memory 202 can be a random access memory (RAM) such as a static random access memory (SRAM) or dynamic random access memory (DRAM), or any other suitable memory.

I/O devices 203 can include any suitable device that allows for data input and/or output. For example, I/O devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allows for the transfer (e.g., uploading and/or downloading) of data, such as component model data.

Display 206 can display user interface 205. User interface 205 can enable user interaction with property search and claim computing device 102. For example, user interface 205 can be a user interface for a property search application that allows for the automatic searching and claiming of assets as described herein. In some examples, a user can interact with user interface 205 by engaging I/O devices 203. In example embodiments, display 206 can be a touchscreen, with user interface 205 displayed on the touchscreen.

Transceiver 204 allows for communication with a network, such as communication network 118 shown in FIG. 1. For example, if communication network 118 is a 5G network, transceiver 204 is configured to allow communications with the 5G network. Processor(s) 201 is operable to receive data from, or send data to, a network, such as communication network 118, via transceiver 204.

Referring again to FIG. 1, property search and claim system 100 allows for the automatic search of unclaimed property by leveraging various data, such as tax data gathered during the income tax compliance process, as well as the automatic claiming of any found unclaimed property. Among other advantages, property search and claim system 100 allows a user to conduct a more comprehensive search for unclaimed property, and overcomes deficiencies inherent to unclaimed property databases, such as those described herein.

For instance, unclaimed property search device 120A may be operated or utilized by a corresponding agency 122A (e.g., a state agency), and may provide a digital interface (e.g., a webpage, web portal, a supported web service endpoint, etc.) that allows for the search of unclaimed property for a corresponding jurisdiction. The jurisdiction may be, for example, a state (e.g., the State of Pennsylvania), a county, or any other suitable jurisdiction. The digital interface may allow for the input of data, such as a name and address of a person for whom a search of unclaimed property is to be executed. As illustrated, unclaimed property search device 120A may be communicatively coupled to unclaimed property search database 121A, which may store data related to unclaimed property. For instance, unclaimed property search database 121A may store data records that identify a property (e.g., a financial asset) and a corresponding owner of that property. Based on search data received by unclaimed property search device 120A (e.g., search data received based on input fields of the digital interface), unclaimed property search device 120A may retrieve one or more of the data records stored within the unclaimed property search database 121A, and may provide the retrieved data records for display. For instance, based on received search data, unclaimed property search device 120A may transmit the data records over communication network 118 to property search and claim computing device 102, and property search and claim computing device 102 may display the data records within display 206.

Similarly, unclaimed property search device 120B may be operated or utilized by another agency 122B, and may provide a digital interface that allows for the search of unclaimed property for a different jurisdiction, such as a different state or county. Unclaimed property search device 120B may be communicatively coupled to unclaimed property search database 121B, which may store data related to unclaimed property for the different jurisdiction. Unclaimed property search device 120B may receive search data based on input fields provided by its corresponding digital interface, and may retrieve data records stored within the unclaimed property search database 121B based on the search data. Unclaimed property search device 120B may provide the search data for display. For instance, based on received search data, unclaimed property search device 120B may transmit the data records over communication network 118 to property search and claim computing device 102, and property search and claim computing device 102 may display the data records within display 206.

Data retrieval device 126A may be any suitable device or system that allows for the retrieval of data, such as personal information (e.g., name, address, phone number, social security number, credit reports, etc.). The data may also include public records, such as marriage license names, property records, business names, among other records. Data retrieval device 126A may be communicatively coupled to a database 126B that stores the data, and may be operated or utilized by a data providing agency 127 (e.g., state or federal division, private company, social media platform or company, etc.). For instance, the data providing agency 127 may be a credit reporting agency, a state or county records agency (e.g., a real property appraiser office, county recorder's office, secretary of state, division of corporations, etc.), or a social media application or website, among other examples. Although only one data providing agency 127 is illustrated merely for convenience, in other example embodiments, multiple data providing agencies 127 may provide data (e.g., different forms and types of data).

Database 116 may store client information 130, property search model data 140, and property search digital interface template data 150. Client information 130 may include, for example, tax data 132, which may identify and/or characterize tax information filed with or obtained by governmental tax agencies (e.g., federal, state, and/or local tax returns and corresponding forms and information, such as federal, state, and/or local tax forms including, without limitation, W2 forms, 1099 forms, and other related forms) for one or more years for a client (e.g., a taxpayer). For example, tax data 132 may include one or more of a client's legal name, client's social security number, client's date of birth, client's spouse's legal name, client's spouse's social security number, client's spouse's date of birth, home addresses, employer addresses, business addresses, rental property addresses, and sources of passive income streams such as financial institution names and addresses. Client information 130 may also include customer identification data 135, which may include, for instance, information received from one or more data retrieval devices 126A for a client (e.g., credit report, property records, driver's license image and/or number, employment location, school location, etc.). In example embodiments, based on at least a portion of tax data 132 and/or customer identification data 135 for a client, property search and claim computing device 102 performs operations to search one or more agencies 122A, 122B for unclaimed property and, if approved by a client, automatically claims such property, as described herein.

For example, property search and claim computing device 102 may obtain, from database 116, property search model data 140 that identifies and characterizes one or more models (e.g., algorithms) that, when executed by property search and claim computing device 102, generates property search data 134 for one or more jurisdictions. The property search data 134, as described herein, identifies and characterizes search data (e.g., text) and/or search criteria to search for unclaimed property for the client (e.g., by searching digital interfaces provided by unclaimed property search devices 120A, 120B).

In example embodiments, property search model data 140 identifies and characterizes a set of rules that are applied to at least portions of tax data 132 and/or customer identification data 135 to generate the property search data 134. For example, the rules, when executed by property search and claim computing device 102, may include generating property search data 134 for any jurisdiction, e.g., state, county, and/or municipality, in which the client had a home address over a previous number of years (e.g., 10 years, ever, etc.). As another example, the rules, when executed by property search and claim computing device 102, may include generating property search data 134 for any jurisdiction in which the client's spouse had a home address, or a client's relative (e.g., a sibling, a parent, a child, a cousin, etc.) had a home address.

The rules may also specify the type of search to perform in a given jurisdiction. For example, the rules may specify whether to perform a search based on the client's first and last name and home address, or just on the client's first and last name. For instance, a rule may indicate that only the client's name be searched when searching a jurisdiction where the client's parents, but not the client, had a home address. In some examples, the rules may include a name table (e.g., stored in database 116) that identifies additional first names and/or last names for which to search. For instance, if a client's name is “Robert,” the rules may specify that a search also be perform using “Bob” as a first name (e.g., when the client's tax data 132 indicates that the client also goes by “Bob.”).

In example embodiments, property search model data 140 identifies and characterizes a trained, artificial intelligence or machine learning model. For instance, property search model data 140 may identify and characterize a neural network, a gradient-boosted, decision-tree model, a random-forest model, a KNN model, a K-means model, linear model, or any other suitable artificial intelligence or machine learning model. For instance, property search model data 140 may include weights and/or tuned hyperparameters that characterize the trained, artificial intelligence or machine learning model. Property search and claim computing device 102 may obtain property search model data 140 and establish the corresponding trained, artificial intelligence or machine learning model based on the obtained property search model data 140. Further, property search and claim computing device 102 may generate input features based on the portions of tax data 132 and/or customer identification data 135, and may input the generated features into the established trained, artificial intelligence or machine learning model to generate the property search data 140.

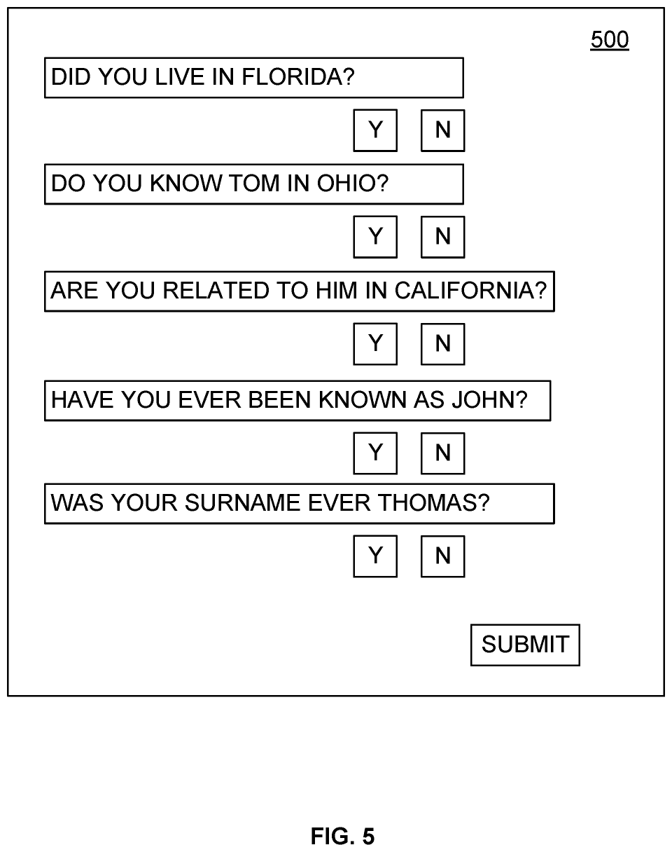

In certain example embodiments, property search and claim computing device 102 may generate one or more questions based on at least portions of tax data 132 and/or customer identification data 135, and may transmit question data identifying and characterizing the questions to user computing device 112. For example, based on the portions of tax data 132 and/or customer identification data 135, property search and claim computing device 102 may generate question data characterizing questions such as “Do you also go by Bob?,” “Did you live at 1234 Main Street?,” or “Are there any common misspellings to your name?” Property search and claim computing device 102 may generate the questions based on execution of the one or more rules, or the established trained, artificial intelligence or machine learning model, as described herein. For instance, the established trained, artificial intelligence or machine learning model may have “learned” during training that people named Robert may also go by Bob, and may generate output data characterizing the question. Property search and claim computing device 102 may transmit the question data characterizing the questions to user computing device 112, which may cause user computing device 112 to open (e.g., activate) a property search application (“PS App”) that presents the questions to the user, and allows the user to input responses to the questions. For example, FIG. 5 illustrates a PS App 500 that may be displayed by user computing device 112. As illustrated, PS App 500 displays various questions, along with a “Y” icon and a “N” icon for the user to select. Once the selections are made, the user may click on a “SUBMIT” icon. PS App 500 may then generate question response data characterizing the selected responses, and may transmit the question response data to property search and claim computing device 102.

Referring back to FIG. 1, user computing device 112 generates question response data 138 based on the inputted responses, and transmits question response data 138 to property search and claim computing device 102. Property search and claim computing device 102 may store question response data 138 within database 116. Further, property search and claim computing device 102 may generate property search data 140 based on question response data 138. For example, if question response data 138 indicates the client answered “No” to the question of “Do you also go by Bob?” property search and claim computing device 102 may remove, or not generate, property search data 140 to search for properties that are owned by “Bob.”

Further, in some example embodiments, property search and claim computing device 102 formats property search data 140 in accordance with a digital interface provided by corresponding unclaimed property search device 120A, 120B. For instance, database 116 may store property search digital interface template data 150 that identifies and characterizes a digital interface of an unclaimed property search device 120A, 120B. As described herein, the digital interface may allow for the searching of unclaimed property. Property search and claim computing device 102 may obtain property search digital interface template data 150 for the jurisdiction for which property search data 140 was generated, and may format property search data 140 in accordance with the property search digital interface template data 150. For instance, property search digital interface template data 150 may indicate that a first field of the digital interface is for a first name of a person, a second field of the digital interface is for a last name of the person, and a third field is for an address of the person. Property search and claim computing device 102 may format property search data 140 such that the first name of the client corresponds to the first field of the digital interface, the last name of the client corresponds to the second field of the digital interface, and an address of the client corresponds to the third field of the digital interface.

In some example embodiments, search digital interface template data 150 also identifies whether a field is required for a search, or whether a field is optional for a search. If a field is required, property search and claim computing device 102 signals an error if property search data 140 does not include the required information. The signaled error may be a popup window on display 206, an SMS (e.g., text) or email to a user of property search and claim computing device 102, or any other suitable signal indicating the error.

Once formatted in accordance with the corresponding property search digital interface template data 150, property search and claim computing device 102 may transmit the formatted property search data 140 to the corresponding unclaimed property search device 120A, 120B. The formatted property search data 140 may be transmitted in accordance with a Hypertext Transfer Protocol (HTTP) request for a Uniform Resource Locator (URL) of the digital interface, for instance.

Further, when received, the formatted property search data 140 causes the corresponding unclaimed property search device 120A, 120B to search the unclaimed property records within its corresponding database 121A, 121B for unclaimed property based on the received property search data, and to generate unclaimed property data 136 identifying and characterizing any unclaimed property found (e.g., matched) based on the search. The corresponding unclaimed property search device 120A, 120B may transmit the unclaimed property data 136 (e.g., as an HTTP response) to property search and claim computing device 102, and, upon receiving unclaimed property data 136, property search and claim computing device 102 may store unclaimed property data 136 within database 116.

In some example embodiments, property search and claim computing device 102 displays at least a portion of unclaimed property data 136 within display 206 (e.g., within user interface 205). A user may select whether to claim any of the identified unclaimed property. For instance, assuming unclaimed property data 136 identifies a checking account, property search and claim computing device 102 may display the information received identifying the checking account, and a request for the user to select whether the user would like to claim the checking account. If the user selects to claim the checking account, property search and claim computing device 102 generates a claim request for the checking account, and transmits the claim request to the corresponding unclaimed property search device 120A, 120B to claim the checking account.

In some example embodiments, property search and claim computing device 102 transmits at least a portion of unclaimed property data 136 to a user's device, such as user computing device 112. The transmitted portions of unclaimed property data 136 causes or activates user computing device 112 to open PS App 500, shown in FIG. 5, and display the portions of unclaimed property data 126. PS App 500 also allows the user to select for claiming any of the displayed unclaimed property. User computing device 112 transmits the selected unclaimed properties to property search and claim computing device 102. Based on the received unclaimed properties to claim, property search and claim computing device 102 generates a claim request, and transmits the claim request to the corresponding unclaimed property search device 120A, 120B for claiming.

As such, and as described herein, property search and claim computing device 102 may obtain tax data 132 from database 116 and, based on tax data 132, generate property search data 134 for an unclaimed property digital interface provided by an unclaimed property processing device, such as an unclaimed property digital interface provided by unclaimed property search device 120A. Further, property search and claim computing device 102 may transmit property search data 134 to unclaimed property search device 120A. In response, property search and claim computing device 102 may receive, from unclaimed property search device 120A, unclaimed property data, such as unclaimed property data 136. Property search and claim computing device 102 may then provide unclaimed property data 136 for display. For instance, property search and claim computing device 102 may display at least a portion of unclaimed property data 136 within display 206, and/or may transmit one or more portions of unclaimed property data 136 to user computing device 112 for display. Property search and claim computing device 102 may, in response to the displayed portions of unclaimed property data 136, receive a selection of unclaimed properties to claim. In response to the selection, property search and claim computing device 102 may transmit a corresponding claim request for the selected property.

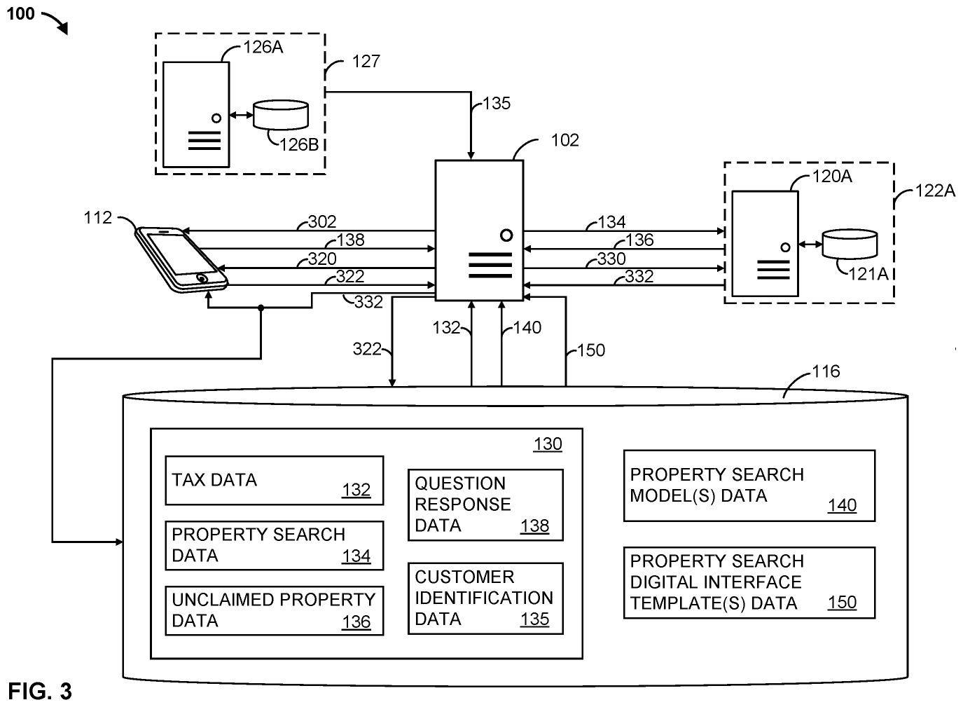

FIG. 3 illustrates example messaging between property search and claim computing device 102, unclaimed property search device 120A, data retrieval device 126A, and user computing device 112. For example, and for a given client, property search and claim computing device 102 may receive customer identification data 135 (e.g., a credit report, a property record, etc.) from data retrieval device 126A. Further, property search and claim computing device 102 may obtain, for the client, tax data 132 from database 116, and may generate property search data 134, and a question request 302, based on customer identification data 135 and/or tax data 132 as described herein. For example, property search and claim computing device 102 may establish one or more models characterized by property search model data 140, and may apply the one or more established models to customer identification data 135 and/or tax data 132 to generate property search data 134 and the one or more inquires for the client. Property search and claim computing device 102 may then generate question request 302 based on the one or more inquires, and may transmit question request 302 to user computing device 112.

In response to receiving question request 302, user computing device 112 may display the questions (e.g., as presented by PS App 500 described herein) to the user. The user may provide input to, e.g., PS App 500, and user computing device 112 may generate question response data 138 identifying and characterizing the responses. User computing device 112 may then transmit question response data 138 to property search and claim computing device 102.

Further, and based on question response data 138, property search and claim computing device 102 may adjust property search data 134 (e.g., by removing requests for property owned by “Bob”). Property search and claim computing device 102 may then format property search data 134 in accordance with a corresponding property search digital interface template, such as one characterized by property search digital interface template data 150 stored in database 116. For instance, property search and claim computing device 102 may obtain property search digital interface template data 150 for the digital interface provided by unclaimed property search device 120A from database 116, and may format property search data 134 accordingly. Property search and claim computing device 102 may then transmit the formatted property search data 134 to unclaimed property search device 120A.

In response to transmitting the formatted property search data 134, property search and claim computing device 102 may receive from unclaimed property search device 120A unclaimed property data 136 characterizing one or more unclaimed property. Property search and claim computing device 102 may then generate an unclaimed property claim request message 320 that includes at least a portion of unclaimed property data 136, and may transmit unclaimed property claim request message 320 to user computing device 112. Unclaimed property claim request message 320 may identify, for example, one or more properties (e.g., financial assets), and an owner (e.g., first name, last name, last known address, etc.) for each financial asset.

In response to receiving unclaimed property claim request message 320, user computing device 112 may display to a user, within PS App 500 as described herein, at least a portion of unclaimed property data 136 (e.g., the one or more properties and corresponding owners information). Further, PS App 500 may allow the user to select which, if any, of the properties for which the user would like to submit a claim. Based on the selections, user computing device 112 may generate an unclaimed property claim response message 322 that identifies the properties selected. For instance, unclaimed property claim response message 322 may indicate that a first property, a third property, and a seventh property were selected, while a second property, a fourth property, a fifth property, and a sixth property were not selected. User computing device 112 may transmit the unclaimed property claim response message 322 to property search and claim computing device 102.

In some example embodiments, property search and claim computing device 102 receives unclaimed property claim response message 322, and stores unclaimed property claim response message 322 in database 116. Further, property search and claim computing device 102 may generate a claim request message 330 based on the properties identified as selected within unclaimed property claim response message 322. Claim request message 330 may be generated and formatted in accordance with a claim request format expected by unclaimed property search device 120A. For instance, property search digital interface template data 150 may include a digital template for the claim request digital interface of unclaimed property search device 120A. Property search and claim computing device 102 may obtain the corresponding digital template, which may identify fields (e.g., required fields and/or optional fields) of the digital interface, and may generate claim request message 330 in accordance with the obtained template. Property search and claim computing device 102 may then transmit claim request message 330 to unclaimed property search device 120A for claim processing.

In some example embodiments, property search and claim computing device 102 receives, from unclaimed property search device 120A, a claim response message 332 that indicates whether the property claims received in claim request message 330 were successful or not. For example, claim response message 332 may indicate that the property claims for the first property and the seventh property were accepted and approved, and may further indicate that the property request for the third property was not approved. Property search and claim computing device 102 may store at least a portion of claim response message 332 within database 116. In some examples, property search and claim computing device 102 may transmit claim response message 332 to user computing device 112 for display, via PS App 500, to the client.

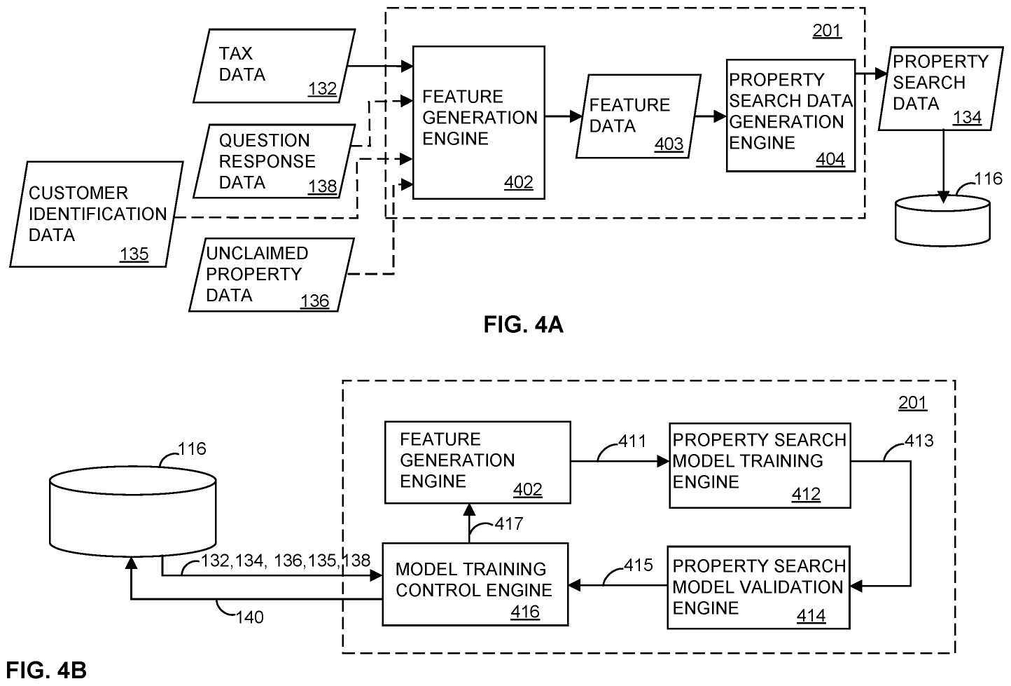

FIG. 4A illustrates exemplary portions of property search and claim computing device 102 including a feature generation engine 402 and a property search data generation engine 404, each of which, in some example embodiments, may be executed by one or more processors 201 of property search and claim computing device 102. In other examples, one or more of feature generation engine 402 and property search data generation engine 404 may be implemented by any suitable circuitry, as described herein.

In this example embodiment, feature generation engine 402 receives tax data 132 (e.g., from database 116), and generates feature data 403 that includes input feature data to be inputted into an executed trained artificial intelligence or machine learning process. In some examples, feature generation engine 402 also receives one or more of customer identification data 135, question response data 138, and previously obtained unclaimed property data 136 (e.g., unclaimed property data 136 previously generated for the same or different client), and generates feature data 403 based on tax data 132 and one or more of customer identification data 135, question response data 138, and previously obtained unclaimed property data 136.

Property search data generation engine 404 receives the generated feature data 402, and applies one or more trained artificial intelligence or machine learning processes to the feature data to generate property search data 134. As described herein, property search data 134 may identify and characterize search data and/or search criteria to search digital interfaces provided by unclaimed property search devices 120A, 120B. For example, property search data generation engine 404 may obtain, from database 116, property search model data 140 that characterizes a trained machine learning model, and may establish the trained machine learning model based on the property search model data 140. For instance, property search data generation engine 404 may initialize parameters, weights, and/or hyperparameters of the trained machine learning model based on property search model data 140. Further, property search data generation engine 404 may input feature data 403 into the established and trained machine learning model and, based on execution of the trained machine learning model, may output property search data 134. Property search data generation engine 404 may store the generated property search data 134 in database 116.

FIG. 4B illustrates exemplary portions of property search and claim computing device 102 including feature generation engine 402, as well as a property search model training engine 412, property search model validation engine 414, and model training control engine 416, each of which, in some example embodiments, may be executed by one or more processors 201 of property search and claim computing device 102. In other examples, one or more of feature generation engine 402, property search model training engine 412, property search model validation engine 414, and model training control engine 416 may be implemented by any suitable circuitry, as described herein.

In this example embodiment, feature generation engine 402, property search model training engine 412, property search model validation engine 414, and model training control engine 416 function to train an artificial intelligence or machine learning model, such as one characterized by property search model data 140. For example, model training control engine 416 may obtain, from database 116, one or more of tax data 132, customer identification data 135, question response data 138, property search data 134, and unclaimed property data 136, which have been previously generated. For example, tax data 132, customer identification data 135, question response data 138, unclaimed property data 136, and property search data 134 may have been generated (e.g., as described herein, or as part of one or more aggregated datasets), over a previous temporal period, such as over the last month, the last quarter, the last year, or a previous season. In some example embodiments, tax data 132, customer identification data 135, question response data 138, and/or unclaimed property data 136 are tagged for supervised learning. In some example embodiments, tax data 132, customer identification data 135, question response data 138, and/or unclaimed property data 136 are tagged as inputs, and property search data 134 is tagged as expected output. Further, model training control engine 416 may aggregate the obtained data, and may provide aggregated training data 417 to feature generation engine 402.

Further, and as described herein, feature generation engine 402 may generate features based on training data 427, and may provide generated feature data 411 to property search model training engine 412 for training the artificial intelligence or machine learning model to determine property search data 134 for searching one or more unclaimed property search devices 120A. For instance, property search model training engine 412 may establish an untrained artificial intelligence or machine learning model, and may input the generated feature data 411 to the untrained artificial intelligence or machine learning model to train, for instance, weights, parameters, and/or hyperparameters of the untrained artificial intelligence or machine learning model. Further, and based on the training, property search model training engine 412 may generate output training data 413 characterizing the output of the in-training artificial intelligence or machine learning model.

Property search model validation engine 414 may receive output training data 413 from property search model training engine 412, and may perform one or more processes to determine whether the in-training artificial intelligence or machine learning model is sufficiently trained. For instance, property search model validation engine 414 may compute one or more metrics, such as, but not limited to, precision values, recall values, and area under curve (AUC) for receiver operating characteristic (ROC) curves, precision-recall (PR) curves, or F1 scores to determine whether the in-training artificial intelligence or machine learning model is sufficiently trained. In some examples, property search model validation engine 414 determines that the in-training artificial intelligence or machine learning model is sufficiently trained when one or more computed metrics achieve a corresponding threshold (e.g., are greater than, or equal to, a corresponding threshold). Property search model validation engine 414 may generate training status data 415 indicating whether the in-training artificial intelligence or machine learning model is sufficiently trained. For instance, if the one or more computed metrics have not reached their corresponding thresholds, training status data 415 indicates that the in-training artificial intelligence or machine learning model is not sufficiently trained. Otherwise, if the one or more computed metrics have reached their corresponding thresholds, training status data 415 indicates that the in-training artificial intelligence or machine learning model is sufficiently trained. Property search model validation engine 414 may provide training status data 415 to model training control engine 416.

Further, model training control engine 416 may determine whether to continue training the artificial intelligence or machine learning model based on training status data 415. For instance, if training status data 415 indicates that the in-training artificial intelligence or machine learning model is not sufficiently trained, model training control engine 416 may generate additional aggregated training data 417, and provide aggregated training data 417 to feature generation engine 410 for continued training of the in-training artificial intelligence or machine learning model, as described herein. If, however, training status data 415 indicates that the in-training artificial intelligence or machine learning model is sufficiently trained, model training control engine 416 may store, in database 116, property search model data 140 characterizing the trained artificial intelligence or machine learning model.

In some example embodiments, the in-training artificial intelligence or machine learning model is trained based on a first dataset of aggregated training data 417. Once trained, a second dataset of aggregated training data 417 is generated and applied to the in-training artificial intelligence or machine learning model for validation (e.g., based on computing the one or more metrics as described herein). If the metrics meet their corresponding thresholds, training of the artificial intelligence or machine learning model is complete. If the metrics do not meet their corresponding thresholds, training of the artificial intelligence or machine learning model continues with a third data set, followed by a fourth dataset for further validation, if necessary.

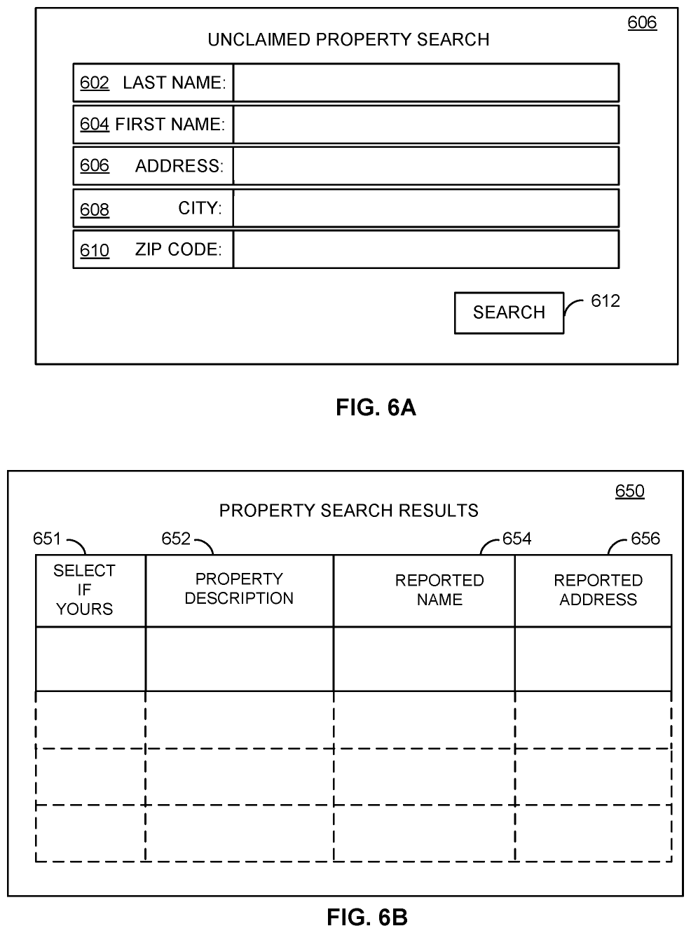

FIG. 6A illustrates an exemplary digital interface 600 that may be provided by an unclaimed property search device, such as any of unclaimed property search devices 120A, 120B. In this example, digital interface 600 includes a first field 602 for inputting a last name, as well as a second field 604 for inputting a first name. In addition, digital interface 600 includes a third field 606 for inputting an address, a fourth field 608 for inputting a city, and a fifth field 610 for inputting a zip code. Digital interface 600 may also include a “Search” icon 612 that, when engaged, causes the unclaimed property search device to perform an unclaimed property search in accordance with data inputted into any of fields 602, 604, 606, 608, 610. As described herein, property search and claim computing device 102 may generate property search data 140 in accordance with various fields 602, 604, 606, 608, 610 of digital interface 600 (e.g., based on a corresponding property search digital interface template data 150 for digital interface 600).

FIG. 6B illustrates an exemplary digital interface 650 that may be provided by an unclaimed property search device, such as any of unclaimed property search devices 120A, 120B, in response to a performed search. In this example embodiment, digital interface 650 includes a first column 651 for selecting whether a property is to be claimed, a second column 652 describing the property (e.g., financial asset such as a checking account), a third column 654 identifying an owner's name, and a fourth column 656 identifying an address (e.g., property address, such as bank address holding the checking account). As described herein, the unclaimed property search device 120A, 120B may transmit to property search and claim computing device 102 at least a portion of the data displayed within columns 651, 652, 654, 656 as unclaimed property data 136.

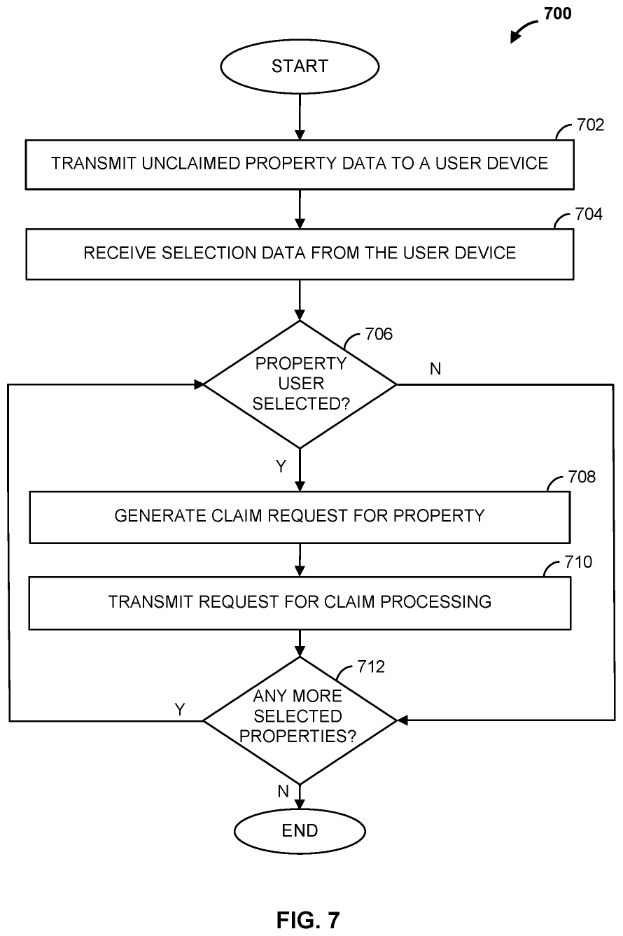

FIG. 7 is a flowchart of an example method 700 that can be carried out by property search and claim computing device 102 of FIG. 1. Beginning at block 702, property search and claim computing device 102 transmits unclaimed property data to a user device. For instance, property search and claim computing device 102 may transmit an unclaimed property claim request message 320, that may include at least a portion of unclaimed property data 136 received from an unclaimed property search device 120A, 120B, to a user computing device 112. The unclaimed property data may cause the user device to display to a user one or more unclaimed properties, and may allow the user to select one or more of the properties for automatic claiming. At block 704, property search and claim computing device 102 receives selection data from the user device. The selection data characterizes any property selections made by the user. For instance, property search and claim computing device 102 may receive from user computing device 112, in response to unclaimed property claim request message 320, an unclaimed property claim response message 322 that identifies the properties (e.g., financial assets) selected.

Further, and at block 706, property search and claim computing device 102 determines whether each property identified in the transmitted unclaimed property data was selected based on the received selection data. For example, if a property is not selected, method 700 proceeds to block 712 to determine if there are any more properties. If, at block 706, a property is selected, method 700 proceeds to block 708. At block 708, property search and claim computing device 102 generates a claim request for the selected property. For instance, property search and claim computing device 102 may generate a claim request message 330 for the selected property. As described herein, the claim request may be formatted in accordance with a claim request format expected by the corresponding unclaimed property search device, such as unclaimed property search device 120A, 120B.

Further, and at block 710, property search and claim computing device 102 transmits the claim request to the unclaimed property search device for claim processing. Method 700 then proceeds to block 712 where property search and claim computing device 102 determines if there are any more properties that are identified within the unclaimed property data transmitted to the user device. If there are any additional properties, method 700 proceeds back to block 706. Otherwise, method 700 ends.

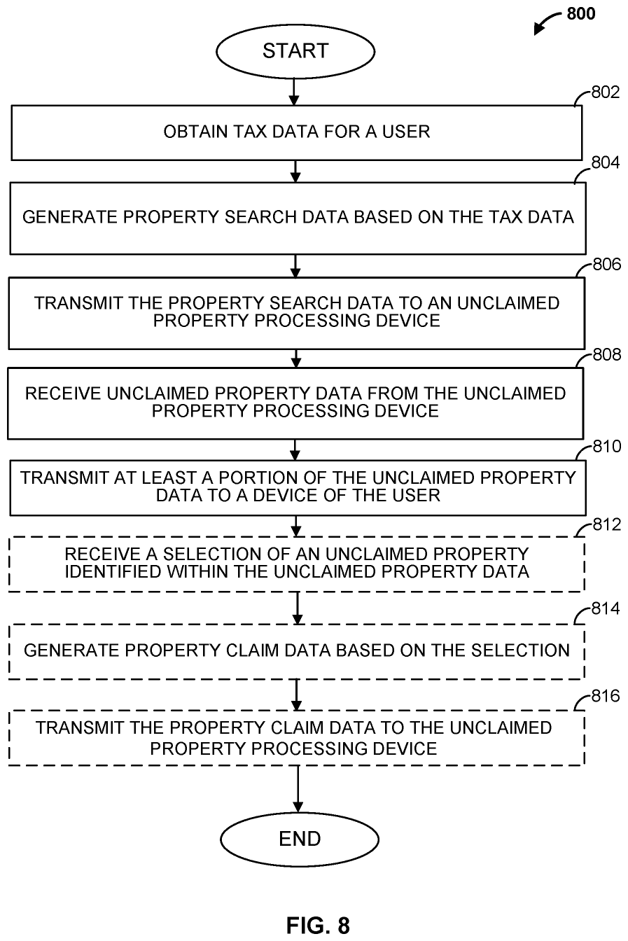

FIG. 8 is a flowchart of another example method 800 that can be carried out by property search and claim computing device 102 of FIG. 1. Beginning at block 802, property search and claim computing device 102 obtains tax data for a user. For instance, property search and claim computing device 102 may obtain tax data 132 from database 116 for a client. At block 804, property search and claim computing device 102 generates property search data based on tax data 132. For example, and as described herein, property search and claim computing device 102 may apply a trained artificial intelligence or machine learning model to tax data 132 to generate property search data 134.

Further, at block 806, property search and claim computing device 102 transmits property search data 134 to an unclaimed property processing device. For example, property search and claim computing device 102 may format property search data 134 in accordance with a property search digital interface template characterized by property search digital interface template data 150, and may transmit the formatted property search data 134 to a corresponding unclaimed property search device 120A, 120B. The formatted property data 134, when received, may cause the unclaimed property search device 120A, 120B to search a database based on the formatted property search data 134

At block 808, property search and claim computing device 102 may receive unclaimed property data from the unclaimed property processing device. For instance, and as described herein, property search and claim computing device 102 may receive unclaimed property data 136 from unclaimed property search device 120A, 120B, where unclaimed property data 136 identifies unclaimed properties. Further, and at block 810, property search and claim computing device 102 transmits at least a portion of the unclaimed property data to a device of the user. For instance, property search and claim computing device 102 may generate an unclaimed property claim request message 320 that includes at least a portion of unclaimed property data 136, and may transmit unclaimed property claim request message 320 to user computing device 112.

In some example embodiments, and in response to the transmitted portion of the unclaimed property data, at block 812 property search and claim computing device 102 receives a selection of an unclaimed property identified within the transmitted portion of the unclaimed property data. For example, property search and claim computing device 102 may receive from user computing device 112, in response to unclaimed property claim request message 320, an unclaimed property claim response message 322 that identifies the properties (e.g., financial assets) selected.

Further, in some example embodiments, at block 814 property search and claim computing device 102 generates property claim data based on the received property selections. The property claim data characterizes a claim for the property. For instance, and as described herein, property search and claim computing device 102 may generate a claim request message 330 for a selected property that is in accordance with a digital template of the property search digital interface template data 150 that pertains to a claim request digital interface of the unclaimed property processing device.

In some example embodiments, at block 816, property search and claim computing device 102 transmits the property claim data to the unclaimed property processing device. In some instances, property search and claim computing device 102 receives, from the unclaimed property processing device, a claim response message 332 that indicates whether the property claim received in claim request message 330 was successful or not. Property search and claim computing device 102 may transmit claim response message 332 to the device of the user, e.g., user computing device 112. Method 800 then ends.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A computing device comprising:
a memory storing instructions; and
at least one processor communicatively coupled to the memory, wherein the at least one processor is configured to execute the instructions to:
obtain tax data from a database;
generate, based on the tax data, property search data for an unclaimed property digital interface provided by an unclaimed property processing device;
transmit the property search data to the unclaimed property processing device;
receive, from the unclaimed property processing device, unclaimed property data; and
provide the unclaimed property data for display.

2. The computing device of claim 1, wherein the at least one processor is configured to execute the instructions to:
transmit at least a portion of the unclaimed property data to a customer computing device;
receive, from the customer computing device, a selection of at least one property identified within the portion of the unclaimed property data;
generate a claim request message based on the selection of the at least one property; and
transmit the claim request message to the unclaimed property processing device.

3. The computing device of claim 2, wherein the at least one processor is configured to execute the instructions to generate the claim request message in accordance with a digital template for a claim request digital interface of the unclaimed property processing device.

4. The computing device of claim 1, wherein the at least one processor is configured to execute the instructions to:
obtain, from the database, a digital template for the unclaimed property digital interface of the unclaimed property processing device; and
generate the property search data based on the digital template.

5. The computing device of claim 1, wherein the at least one processor is configured to execute the instructions to:
generate question data characterizing one or more questions based on the tax data;
transmit at least a portion of the unclaimed property data to a customer computing device;
receive, from the customer computing device, question response data characterizing at least one response to the one or more questions; and
generate the property search data based on the question response data.

6. The computing device of claim 1, wherein the at least one processor is configured to execute the instructions to execute one or more rules based on the tax data to generate the property search data.

7. The computing device of claim 1, wherein the at least one processor is configured to execute the instructions to apply a trained artificial intelligence or machine learning model to the tax data to generate the property search data.

8. The computing device of claim 7, wherein the at least one processor is configured to execute the instructions to train the artificial intelligence or machine learning model based on historical tax data.

9. The computing device of claim 1, wherein the at least one processor is configured to execute the instructions to:
receive customer identification data from a data retrieval device; and
generate the property search data based on the customer identification data.

10. A method by at least one processor, the method comprising:
obtaining tax data from a database;
generating, based on the tax data, property search data for an unclaimed property digital interface provided by an unclaimed property processing device;
transmitting the property search data to the unclaimed property processing device;
receiving, from the unclaimed property processing device, unclaimed property data; and
providing the unclaimed property data for display.

11. The method of claim 10, further comprising:
transmitting at least a portion of the unclaimed property data to a customer computing device;
receiving, from the customer computing device, a selection of at least one property identified within the portion of the unclaimed property data;
generating a claim request message based on the selection of the at least one property; and
transmitting the claim request message to the unclaimed property processing device.

12. The method of claim 11, further comprising generating the claim request message in accordance with a digital template for a claim request digital interface of the unclaimed property processing device.

13. The method of claim 10, further comprising:
obtaining, from the database, a digital template for the unclaimed property digital interface of the unclaimed property processing device; and
generating the property search data based on the digital template.

14. The method of claim 10, further comprising:
generating question data characterizing one or more questions based on the tax data;
transmitting at least a portion of the unclaimed property data to a customer computing device;
receiving, from the customer computing device, question response data characterizing at least one response to the one or more questions; and
generating the property search data based on the question response data.

15. The method of claim 10, further comprising executing one or more rules based on the tax data to generate the property search data.

16. The method of claim 10, further comprising applying a trained artificial intelligence or machine learning model to the tax data to generate the property search data.

17. A non-transitory, computer readable medium having instructions stored thereon, wherein the instructions, when executed by at least one processor, cause a device to perform operations comprising:
obtaining tax data from a database;
generating, based on the tax data, property search data for an unclaimed property digital interface provided by an unclaimed property processing device;
transmitting the property search data to the unclaimed property processing device;
receiving, from the unclaimed property processing device, unclaimed property data; and
providing the unclaimed property data for display.

18. The non-transitory computer readable medium of claim 17, comprising instructions stored thereon that, when executed by the at least one processor, cause the device to perform further operations comprising:
transmitting at least a portion of the unclaimed property data to a customer computing device;
receiving, from the customer computing device, a selection of at least one property identified within the portion of the unclaimed property data;
generating a claim request message based on the selection of the at least one property; and
transmitting the claim request message to the unclaimed property processing device.

19. The non-transitory computer readable medium of claim 18, comprising instructions stored thereon that, when executed by the at least one processor, cause the device to perform further operations comprising generating the claim request message in accordance with a digital template for a claim request digital interface of the unclaimed property processing device.

20. The non-transitory computer readable medium of claim 18, comprising instructions stored thereon that, when executed by the at least one processor, cause the device to perform further operations comprising:
obtaining, from the database, a digital template for the unclaimed property digital interface of the unclaimed property processing device; and
generating the property search data based on the digital template.
